(19) United States
(12) Patent Application Publication
(10) Pub. No.: US 2004/0265586 A1
(43) Pub. Date: Dec. 30, 2004

(54) Sized glass fibres, sizing composition and composites comprising said fibres

(76) Inventors: Michel Gonthier, Jacob Bellecombette (FR); Dino Lombino, La Motte Servolex (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/481,464

(22) PCT Filed: Jun. 5, 2002
(86) PCT No.: PCT/FR02/01904

(30) Foreign Application Priority Data
Jun. 21, 2001 (FR) 01/08221

(51) Int. Cl. B32B 3/00

(52) U.S. Cl. 428/375

(57) ABSTRACT

The subject of the invention is glass strands coated with an essentially aqueous sizing composition which comprises the combination of at least one polyurethane A and at least one polyester B in an A/B weight ratio of less than 3.

The glass strands obtained are used to reinforce polymer matrices for the purpose of manufacturing translucent composites, particularly panels for lightweight roofs.

The invention relates to glass strands coated with a sizing composition which are intended to reinforce organic materials of the polymer type, to the sizing compositions used to coat these strands and to the composites containing these strands.

Glass strands used for reinforcement in general are produced on an industrial scale from streams of molten glass flowing out from numerous orifices of a bushing. These streams are drawn mechanically in the form of continuous filaments and are then gathered into base strands which are then collected, for example by winding them onto a rotating support. Before they are gathered, the filaments are coated with a sizing composition by passing them over a suitable device, such as coating rolls.

The sizing composition proves to be essential for several reasons. Firstly, it acts during manufacture of the strands by protecting the glass filaments from the abrasion that occurs when the latter rub at high speed against the members used to guide and collect them. Next, the sizing composition gives the strand cohesion by creating bonds between the filaments making up the strand, thereby increasing its integrity and consequently making it easier to handle. The sizing composition also plays a paramount role in the manufacture of composites based on polymers reinforced with glass strands by promoting wetting and impregnation of these strands by the polymer which generally has the appearance of a fluid resin.

The materials to be reinforced may incorporate the glass strands in various forms: continuous or chopped strands, fabrics, continuous or chopped strand mats, etc.

The composites intended to be used as translucent panels for walls and roofs are generally reinforced by chopped glass strands having a length of about 50 mm, or more. These panels may especially be obtained by a process which consists in chopping glass strands coming from one or more packages above a conveyor belt transporting the bed of polymer resin intended to impregnate the strands, this resin having the appropriate consistency (for example a liquid, semi-liquid or pasty consistency) and being capable of curing.

This process, which is simple and modifiable both as regards the resin and the density of the strands in the blanket, is particularly suitable for the manufacture of translucent, flat or corrugated, panels based on a thermosetting polymer of the polyester, vinyl ester, acrylic, phenolic or epoxy families. The properties required for this type of panel are an attractive appearance, with as few strands visible as possible (in particular what are called “white strands”), good mechanical properties, possibly good weatherability and, in the case of translucent panels, a high level of translucency.

The quality of the composites obtained by this process depend to a great extent on the properties provided by the glass strands and by the size which coats them. In particular, sizing compositions are sought which allow the strand to open up at the time of chopping so that it can fall onto the conveyor in a uniform manner.

Strands coated with these sizing compositions must also be able to be easily wetted or impregnated to the core (that is to say on the surface of the filaments constituting the strand) by the resin. If impregnation is imperfect, there is a risk of air bubbles being trapped in the resin and the strands have a milky white appearance making them visible through the panel, hence a less attractive final appearance and a loss of transparency.

It is also desirable for the sizing compositions to allow rapid processing, in particular for the strands to be impregnated within a very short space of time, of about 5 to 15 seconds, this being imposed in order to produce these composites under industrial conditions.

Finally, it is necessary that the panels possess mechanical reinforcement properties suitable for the use to which they are intended, in particular good tensile strength.

However, although the sizing composition has to allow the strand to open up, it must allow the strand to retain sufficient integrity to prevent it from bursting at the moment of chopping. Bursting of the strand releases the filaments of which it is made and these filaments have a tendency to agglomerate and form a “fuzz”. The presence of fuzz has two major drawbacks: firstly, it disturbs the proper operation of the chopper and secondly it drops in clusters onto the blanket, thus impairing the quality of impregnation and consequently that of the panel.

It may therefore be appreciated that such compositions are difficult to develop as the intended properties are often somewhat incompatible with one another and that it is consequently necessary to search for the best compromise.

Glass strands that can be used as reinforcements in polymer-based composites have already been proposed, in particular for forming translucent panels or profiled elements. These strands are coated with an aqueous sizing composition which generally includes at least one adhesion promoter combined with other agents useful in sizing, such as lubricants, coupling agents, antistatic agents, etc.

In U.S. Pat. No. 4,752,527, the sizing composition proposed comprises a polyester based on bisphenol A (called “polyester of the bisphenol A type”) as adhesion promoter, a coupling agent, a lubricant and an antistatic agent. The solids content in the composition is from 1 to 30% by weight.

In U.S. Pat. No. 5,219,656 a size is described which comprises, as adhesion promoter, a polyester of the bisphenol A type or an epoxy, a coupling agent, a lubricant and an allyl compound, in particular a triallyl cyanurate. The presence of the latter compound on the surface of the glass strands makes it possible to obtain a composite which retains its translucent character for a longer time.

In U.S. Pat. No. 5,242,958 and U.S. Pat. No. 5,604,270, the adhesion promoter is an epoxy used by itself or in combination with a polyester of the bisphenol A type, a polyurethane, a poly(urea-urethane), a polyesterurethane or a polyetherurethane. The composition furthermore includes a coupling agent and a lubricant.

It has also been proposed to use as adhesion promoter unsaturated compounds having a defined degree of unsaturation for the purpose of controlling the rate of impregnation of the glass strands.

Thus, in U.S. Pat. No. 4,789,593, the sizing composition contains an epoxidized polyester or an esterified epoxy comprising fewer than 1.5 aliphatic double bonds per mole and having a ratio of the number of aliphatic unsaturated groups to the number of aromatic unsaturated groups of less than 0.1, together with a lubricant and a coupling agent.

In U.S. Pat. No. 6,139,958, the adhesion promoter is a polyester of the bisphenol A type or an epoxy esterified by one or more fatty acids containing fewer than 1.4 aliphatic double bonds per mole and possessing a ratio of the number of aliphatic unsaturated groups to the number of aromatic unsaturated groups of less than 0.1, and it is used as a mixture with a poly (vinyl acetate). The composition also includes a coupling agent, a lubricant and an antistatic agent.

The role of the polyester in the compositions just mentioned is to improve the ability of the glass strand to be wetted or impregnated by the resin. This allows a panel having a very high degree of translucency to be obtained. However, the fact remains that the glass strands coated with these sizes have an ability to open up during chopping which remains poor and that their processing is not entirely satisfactory.

The object of the invention is to develop glass strands coated with a sizing composition which, while allowing translucent composite panels of attractive appearance to be obtained, containing few visible strands and exhibiting good mechanical properties, are easier to process, especially owing to the improved way in which they open up during chopping. As indicated above, this is because it is essential for the chopped strands to be able to be uniformly distributed on the conveyor and form a homogeneous blanket, free of any agglomerates of strands and capable of being rapidly impregnated by the resin.

These objectives are achieved by the present invention whose subject is glass strands coated with an essentially aqueous sizing composition, this composition being characterized in that it combines at least one polyurethane (hereafter denoted “A”) and at least one polyester (hereafter denoted “B”) in an A/B weight ratio of less than 3.

In the present invention, the expression “glass strands coated with a sizing composition” is understood to mean glass strands “which have been coated with a sizing composition which comprises . . . ”, that is to say not only glass strands coated with the composition in question, such as those obtained immediately after the sizing member(s), but also the same strands after they have undergone one or more further treatments, for example one or more drying steps, for the purpose of removing water or possible solvents present in the composition, and/or of curing/crosslinking certain constituents of the said composition.

Again within the context of the invention, the term “strands” should be understood to mean the base strands resulting from a multitude of filaments being gathered beneath the bushing, and the products derived from these strands, especially the assemblies of these base strands in the form of rovings. Such assemblies may be obtained by simultaneously unwinding base strands from several packages and then by assembling into fibre bundles which are wound onto a rotating support. They may also be called “direct” rovings having a linear density equivalent to that of assembled rovings, obtained by gathering filaments, directly beneath the bushing, and winding them onto a rotating support.

Also according to the invention, the expression “essentially aqueous sizing composition” is understood to mean a composition which contains at least 90%, preferably at least 93% and even better 94 to 96% water by weight, at least one lubricating agent and at least one coupling agent.

According to a preferred embodiment of the invention, the glass strands are coated with a sizing composition whose polyurethane has a molecular mass of less than 20,000 and preferably between 4,000 and 14,000.

Preferably, the polyurethane is chosen from polyurethanes obtained by the reaction of at least one polyisocyanate with at least one polyol having an aliphatic and/or cycloaliphatic chain.

According to another embodiment of the invention, the glass strands are coated with a sizing composition whose polyester is chosen from polyesters obtained by the reaction of a poly(alkylene glycol) with a carboxylic acid and/or with a carboxylic anhydride. Preferably, the polyester results from the reaction of a poly(alkylene glycol) with phthalic anhydride and maleic anhydride.

The combination of polyurethane A and polyester B proves to be advantageous for forming glass strands having improved opening at chopping. It has been found that the polyurethane, while still being able to bind the strands together, possesses sufficient flexibility for it not to adhesively bond to the filaments too strongly. Consequently strand opening during chopping is improved thereby. It has been discovered that a small amount of polyurethane in the sizing composition is sufficient to obtain the desired effect.

In general, very satisfactory results are obtained by combining polyurethane(s) A with polyester(s) B in an A/B weight ratio of less than or equal to 3, preferably between 0.05 and 2 and better still between 0.25 and 1.5. An A/B ratio of less than or equal to 1 proves to be particularly advantageous as it allows both easy processing during manufacture of the panels and improved properties of the panels obtained, especially as regards tensile strength.

The glass strands coated with a sizing composition combining a polyurethane resulting from the reaction of at least polyisocyanate with at least one polyol having an aliphatic and/or cycloaliphatic chain and a polyester obtained by the reaction of a poly(alkylene glycol) with phthalic and maleic anhydrides prove to be particularly advantageous for the intended manufacture of translucent composite panels.

According to the definition given above, the sizing composition coating the glass strands includes at least one lubricating agent whose function consists especially in protecting the strands from mechanical abrasion during their manufacture and in stiffening the strand. The combination of several lubricants makes it possible in particular to adapt the rate of impregnation of the strands by the resin. The lubricating agent is generally chosen from water-soluble cationic compounds, such polyalkyleneimides, and non-ionic compounds, of the type based on fatty acid esters and on a poly(alkylene glycol) or poly(oxyalkylene), such as polyethylene glycol monolaurate, or of the type based on fatty amides and a poly(oxyalkylene), such as amides of hydrogenated tallow and polyoxyethylene. Preferably, a polyethyleneimide is used.

In accordance with the definition given above, the sizing composition coating the glass strands comprises at least one coupling agent chosen from compounds containing one or more functional organic groups, for example an acryloxy, methacryloxy, glycydoxy or amino group. Preferably, the coupling agent is a silane, and better still an alkoxysilane containing at least one of the aforementioned groups. Methacryloxysilanes, such as gamma-methacryloxypropyltrimethoxysilane, and aminosilanes, such as N-benzylaminoethylpropylammoniumtrimethoxysilane hydrochloride, are preferred.

Advantageously, the composition includes at least two coupling agents, at least one of which is a silane containing at least one acrylic or methacrylic functional group and the other of which is a silane containing at least one amine functional group.

The glass strands coated with the sizing composition according to the invention have a loss on ignition of less than 1.5%, preferably between 0.45 and 0.8% and better still between 0.45 and 0.65.

Usually the glass strands according to the invention are in the form of packages of base strands which are subjected to a heat treatment. This treatment is intended essentially to remove the water and the solvents provided by the sizing composition and, where appropriate, to crosslink the reactive groups of the adhesion promoters. The conditions under which the packages are treated may vary according to the mass of the package. In general, the drying is carried out at a temperature of around 110 to 140° C. for several hours, preferably 12 to 18 hours.

As already mentioned, the base strands thus obtained are generally extracted from the package and joined with several other base strands into a fibre bundle which is then wound onto a rotating support in order to form a roving. It has been found that applying a composition containing a cationic antistatic agent of the quaternary ammonium salt type to the strands makes it possible to remove the electrical charges generated during chopping. Thus, by depositing the aforementioned composition on the base strands, after they have been extracted from the package and assembled to form the bundle, the distribution of the chopped strands and the appearance of the final panel are appreciably improved. Preferably, the strands are coated with an aqueous composition containing 20 to 35%, preferably around 25%, of cocotrimethylammonium chloride by weight. The amount deposited on the strands is generally from 0.01 to 0.05% and preferably around 0.03%.

The strands coated with the sizing composition according to the invention, possibly with the composition described in the previous paragraph, may consist of glass of any kind provided that it is capable of being fiberized, for example E, C and AR glass, and preferably E glass.

These same strands are formed from filaments whose diameter may vary greatly, for example from 9 to 16 μm and preferably from 11 to 13 μm.

Advantageously, the strands have a linear density of between 15 and 60 tex, and better still around 30 tex. Consequently, even when relatively large diameter filaments are used, the strand remains capable of being chopped, forming a uniform blanket, and capable of being rapidly impregnated by the resin, thereby making it possible to have excellent reinforcement while retaining the translucency of the composite panel.

Another subject of the invention is the sizing composition capable of coating the said glass strands, which composition is characterized in that it comprises:

at least one polyurethane A

at least one polyester B

at least one lubricating agent

at least one coupling agent and

water,

the A/B weight ratio being less than 3.

Preferably, the sizing composition comprises:

0.5 to 5% by weight of polyurethane A

1.5 to 5.85% by weight of polyester B

0.02 to 0.04% by weight of lubricating agent

0.10 to 0.33% by weight of coupling agent and

at least 90% water.

A first group of sizing compositions particularly preferred comprises:

2 to 5% by weight of polyurethane A

3.65 to 5.85% by weight of polyester B

0.02 to 0.04% by weight of lubricating agent

0.10 to 0.33% by weight of coupling agent and

at least 90% water.

A second group of sizing compositions also particularly preferred comprises:

0.65 to 1.65% by weight of polyurethane A

1.60 to 2.60% by weight of polyester B

0.02 to 0.04% by weight of lubricating agent

0.10 to 0.33% by weight of coupling agent and

at least 90% water.

Preferably, the sizing composition comprises at least 93%, better still 94%, by weight of water.

Particularly preferably, the composition has an A/B weight ratio of between 0.05 and 2 and better still between 0.25 and 1.5.

It is also possible to introduce other constituents as additives into the sizing composition. As examples of additives, mention may be made of:

organic antistatic agents, such as cationic alkoxylated quaternary ammonium salts, or inorganic antistatic agents, such as chromium chloride or the chloride of an alkali or alkaline-earth metal, especially lithium or magnesium;

crosslinking agents, such as monomers, dimers, trimers or oligomers of melamine-formaldehyde and N-methylole compounds; and

antioxidants, such as sterically hindered phenols, diarylamines, thioethers, quinones and phosphates.

In this case, the total content of these additives does not in general exceed 0.5%, preferably 0.2% by weight of the composition.

The solids content of the sizing composition is generally between 2 and 10%, preferably 2 and 5% and advantageously around 3%.

The subject of the invention is also the composite panels comprising the glass strands coated with the sizing composition. Such panels comprise at least one thermosetting polymer material, preferably a polyester, a vinyl ester, an acrylic, a phenolic resin or an epoxy resin, and glass strands, some or all of which consist of glass strands according to the invention. The glass content within the composite is generally between 20 and 40%, preferably between 25 and 35%, by weight. The thickness of the panel may vary widely, for example from 0.5 to 3 mm and preferably from 1 to 2 mm. In addition to the low content of visible strands and of their translucency, the panels according to the invention are advantageous in that they have a better tensile strength as indicated in the illustrative examples which follow and which allow the invention to be illustrated without however limiting it.

In these examples, the properties relating to the strand coated with the sizing composition and to the composite panel incorporating the said strand are measured as follows:

the loss on ignition, in %, is measured under the conditions in the ISO 1887 standard;

the fuzz and the tension of the strand are measured by making the strand run over a device consisting of eight tensioners at a speed of 50 m/min. The device is placed in a room conditioned to 20° C. and 50% relative humidity. The fuzz is defined by the amount of fibrils, in mg, obtained after 1 kg of the strand has been run out. The tension of the strand, expressed in g, is representative of the behaviour of the strand during the subsequent processing, especially its ability to be unwound. A strand having a tension greater than about 2000 g is not generally satisfactory as it does not easily lend itself to being chopped and has a tendency to fray, impairing the quality of the blanket. This is because such a strand produces a large quantity of fuzz which builds up at the chopper and drops in clusters onto the blanket;

the tensile strength of the strand is measured under the conditions in the ISO 3341 standard. It is expressed in g/30 tex;

the tack (or ability to stick) is determined by means of a device comprising a system for driving the strand at a constant speed (6 m/min) and a metal pulley made of hard chrome steel, connected to a 70 g counterweight and over which the strand slides. The tension of the strand on the pulley is continuously measured over 60 m of strand. The average value of the tension, expressed in g, corresponds to the tack;

the electrostatic charge density is obtained by chopping the strand, freely unwound (no tensioner) by means of a chopper provided with two blades (chopped length: 50 mm; pressure on the anvil roll: 5 kg) and placed in a chamber at 20° C. and at a relative humidity of 20%. The chopped strand is recovered in a metal container equipped with a Faraday cage. The density of changes which have built up during chopping is expressed in nanocoulombs per gram of strand (nC/g);

the openness at chopping allows the quality of the chopped strand dispersion to be evaluated. It is determined by chopping the strand using a chopper (Schmit and Heinzman; chopping speed: 110 rpm; chopped strand length: 50 mm) above a conveyor belt running at a speed of 15 m/min., the chopping being carried out under controlled temperature and humidity conditions (20° C.; 50% relative humidity). A felt (mass: about 15 g) is obtained in which the number of agglomerated strands in the form of logs (2400 tex), sticks (300 to 2400 tex) and clumps (60 to 300 tex) are counted. The openness at chopping is given by the following equation:

openness at chopping=5×(number of logs)+2×(number of sticks)+1×(number of clumps)

in which 5, 2 and 1 are the weighting coefficients reflecting the size of the strands in the intended application;

the rate of 50% impregnation and of 100% impregnation are measured as follows:

A chopped strand preform (200 mm×200 mm; about 50 g) deposited beforehand on a Mylar® sheet, is impregnated with the resin consisting of:

| | |
|---|---|
| non-thixotropic polyester resin | 120 g |
| NORSODINE S 2010 V sold by Cray Valley) | |
| accelerator (NL 51 P sold by Akzo | 0.12 g |
| Nobel) | |
| Catalyst (BUTANOX M 50 sold by Akzo | 1.2 g |
| Nobel) | |

After having deposited the resin on the preform, a chequer-board grid, defining squares having sides of 200 mm separated by 28 mm, is placed on top and the number of squares impregnated by the resin as a function of time is counted. The rate of impregnation is defined by the time needed to obtain 50% impregnation and 100% impregnation of the preform;

the translucency of the composite panel incorporating the strands coated with the sizing composition and the presence of white strands within this panel are assessed visually on a panel made in the following manner:

A chopped strand preform (200 mm×200 mm; about 33 g), deposited beforehand on a Mylar® sheet, is impregnated with the polyester resin having the following composition:

| | |
|---|---|
| Resin 3080 LA (sold by Cray Valley) | 90 g |
| styrene | 9 g |
| LUPEROX K2 catalyst (sold by Elf | 1 g |
| Atochem) | |
| NL 51 P accelerator (sold by Akzo | 0.5 g |
| Nobel) | |

The impregnated preform is covered with a Mylar® sheet and is then outgassed by passing a suitable roller over the preform before it is cured in an oven (temperature rise: 85° C. to 130° C. in 7 minutes).

for the translucency test, the preform is obtained from strands taken from a roving. The translucency is rated on a scale ranging from 1 (not very translucent) to 5 (translucency of window glass).

for the white strand test, the preform is obtained from strands coming from the outer portion of a package of base strand that has undergone the heat treatment. The presence of white strands is rated according to a scale ranging from 1 (very many strands visible) to 5 (not strand visible);

the tensile strength of the panel, in MPa, is measured under the conditions in the ISO 527-4 standard, the panel being manufactured in accordance with the ISO 1268 standard.

### EXAMPLE 1

A sizing composition comprising the following (in % by weight) was prepared:

| | |
|---|---|
| nonionic aliphatic/cycloaliphatic | 2.00 |
| polyurethane⁽¹⁾ (molecular mass: 14 000; | |
| aqueous solution having 33% by weight | |
| of active matter) | |
| nonionic unsaturated polyester⁽²⁾ | 5.85 |
| (aqueous solution having 45% by weight | |
| of active matter) | |
| lubricant: polyethyleneimide⁽³⁾ | 0.025 |
| silane⁽⁴⁾ | 0.23 |
| aminosilane⁽⁵⁾ | 0.10 |
| 90% acidic acid | 0.015 |
| water | qsp 100. |

The A/B weight ratio is equal to 0.25.

The preparation of the sizing composition was carried out in the following manner: the methoxy groups of the silanes⁽⁴⁾ and ⁽⁵⁾ were hydrolysed by adding acid to an aqueous solution of these silanes, the solution being kept stirred. Next, the other constituents of the sizing composition were introduced, again with stirring, and the pH was adjusted to a value of 5.0±0.3 if necessary.

The solids content of the composition thus prepared was 3% by weight.

The sizing composition was used to coat, in a known manner, E glass filaments about 12 μm in diameter drawn from streams of molten glass flowing out of 2400 orifices of a bushing, the filaments then being assembled in the form of a package of base strands having a linear density of 30 tex.

The package was then dried at 130° C. for 12 hours.

An antistatic aqueous solution containing 25 wt % cocotrimethylammonium chloride⁽⁶⁾ was applied to the base strands extracted from the package and assembled into rovings consisting of 80 base strands (solids content deposited: 0.03%).

The properties of the strand unwound from the roving and of the panel incorporating this strand are given in Table 1.

### EXAMPLE 2

The conditions for this example were as in Example 1, but modified in that the polyurethane and polyester contents (in % by weight) were the following:

| | |
|---|---|
| nonionic aliphatic/cycloaliphatic | 3.45 |
| polyurethane⁽¹⁾ | |
| nonionic unsaturated polyester⁽²⁾ | 4.80 |

The A/B weight ratio is equal to 0.538.

The solids content of the composition was 3% by weight. The properties of the strand thus obtained and of the panel incorporating this strand are given in Table 1.

### EXAMPLE 3

The conditions for this example were as in Example 1, but modified in that the polyurethane and polyester contents (in % by weight) were the following:

| | |
|---|---|
| nonionic aliphatic/cycloaliphatic | 5.00 |
| polyurethane⁽¹⁾ | |
| nonionic unsaturated polyester⁽²⁾ | 3.65 |

The A/B weight ratio is equal to 1.

The solids content of the composition was 3% by weight.

The properties of the strand thus obtained and of the panel incorporating this strand are given in Table 1.

### EXAMPLE 4 (COMPARATIVE EXAMPLE)

The conditions for this example were as in Example 1, but modified in that the polyurethane and polyester contents (in % by weight) were the following:

| | |
|---|---|
| nonionic aliphatic/cycloaliphatic | 8.00 |
| polyurethane⁽¹⁾ | |
| nonionic unsaturated polyester⁽²⁾ | 1.45 |

The A/B weight ratio is equal to 4.

The solids content of the composition was 3.2% by weight. The properties of the strand thus obtained and of the panel incorporating this strand are given in Table 1.

### EXAMPLE 5

The conditions for this example were as in Example 1, but modified in that the following constituents were present in the composition (in % by weight):

| | |
|---|---|
| nonionic aliphatic/cycloaliphatic | 3.45 |
| polyurethane⁽¹⁾ | |
| nonionic unsaturated polyester⁽²⁾ | 4.80 |
| aminosilane⁽⁵⁾ | 0.20 |

The A/B weight ratio is equal to 0.538.

The solids content of the composition was 3% by weight. The properties of the strand thus obtained and of the panel incorporating this strand are given in Table 1.

### EXAMPLE 6

The conditions for this example were as in Example 1, but modified in that following constituents were present in the composition (in % by weight):

| | |
|---|---|
| nonionic aliphatic/cycloaliphatic | 5.00 |
| polyurethane⁽¹⁾ | |
| nonionic unsaturated polyester⁽²⁾ | 3.65 |
| aminosilane⁽⁵⁾ | 0.20 |
| lubricant: polyethyleneimide⁽³⁾ | 0.040 |

The A/B weight ratio is equal to 1.

The solids content of the composition was 3% by weight. The properties of the strand thus obtained and of the panel incorporating this strand are given in Table 1.

### EXAMPLE 7 (COMPARATIVE EXAMPLE)

The conditions for this example were as in Example 1, but modified in that the composition contained no nonionic aliphatic/cycloaliphatic polyurethane⁽¹⁾ but did contain 7.3% by weight of nonionic unsaturated polyester⁽²⁾.

The solids content of the composition was 3.8% by weight. The properties of the strand thus obtained and of the panel incorporating this strand are given in Table 1.

### EXAMPLE 8 (COMPARATIVE EXAMPLE)

The conditions for this example were as in Example 1, but modified in that the composition contained no nonionic unsaturated polyester⁽²⁾ but did contain 10% by weight of nonionic aliphatic/cycloaliphatic polyurethane⁽¹⁾.

The solids content of the composition was 3.8% by weight. The properties of the strand thus obtained and of the panel incorporating this strand are given in Table 1.

TABLE 1

| | Example | | | | | | | | | | |
|---|---|---|---|---|---|---|---|---|---|---|---|
| | 1 | 2 | 3 | 4(comp.) | 5 | 6 | 7 (comp.) | 8 (comp.) | C1 (comp.) | C2 (comp.) | C3 (comp.) |
| Size [symbol] ands | | | | | | | | | | | |
| [symbol] ze (%) | 0.45 | 0.63 | 0.47 | 0.77 | 0.54 | 0.62 | 0.64 | 0.65 | 0.62 | 0.54 | 0.77 |
| Fuzz (mg/kg) | 5 | 2 | 3 | 0.5 | 3 | 1 | 30 | 3 | 3 | 6 | 3 |
| Tension (g) | 1745 | 1375 | 1016 | 1900 | 1400 | 690 | n.d. | n.d. | 800 | 1120 | 3000 |
| Solubility in acetone | 80 | 80 | 76 | 83 | 81 | 79 | 83 | 82 | 81 | 74 | 83 |
| (%) | | | | | | | | | | | |
| Tensile strength | 1.75 | 1.73 | 1.74 | 1.78 | 1.95 | 2.22 | n.d. | 1.86 | 1.69 | 1.14 | 1.60 |
| (g/30 tex) | | | | | | | | | | | |
| Tack (g) | 73 | 90 | 64 | 105 | 66 | 65 | >130 | 83 | 40 | 30 | 58 |
| Roving density | 1.34 | 1.32 | 1.29 | 1.33 | 1.31 | 1.32 | 1.47 | 1.27 | 1.29 | 1.28 | 1.23 |
| Openness at | 10 | 10 | 4 | 175 | 15 | 15 | 230 | 90 | 170 | 5 | 80 |
| chopping (number of | | | | | | | | | | | |
| agglomerated strands) | | | | | | | | | | | |
| Electrostatic charge | 4 | 5 | 1 | 4 | 0.2 | 0.5 | n.d. | 4 | 25 | 2 | 27 |
| density (nC/g) | | | | | | | | | | | |
| Impregnation (min) | 3 | 3 | 3 | n.d. | 3 | 3 | n.d. | 2 | 2 | 3 | 3 |
| to 50% | | | | | | | | | | | |
| [symbol] | 6 | 7 | 7 | n.d. | 7 | 7 | n.d. | 4 | 10 | 7 | 5 |
| Composite panel | | | | | | | | | | | |
| Translucency | 4.5 | 4.5 | 4 | 3 | 4.5 | 3.5 | n.d. | n.d. | 4.5 | 3.5 | 4.5 |
| White strands | 4 | 4.5 | 4 | 3 | 4 | 3 | 3 | 2.5 | 3.5 | 2 | n.d. |
| Tensile strength of | n.d. | 114 | 115 | n.d. | 108 | 105 | n.d. | n.d. | n.d | 85 | 94 |
| the panel (Mpa) | | | | | | | | | | | |

n.d.: not determined
comp.: comparative

On examining Table 1, it may be seen that the glass strands of Examples 1 to 3, 5 and 6 according to the invention exhibit good openness at chopping and allow a composite panel having both good translucency and few white strands to be obtained. This level of performance is superior to that of strands coated with a size containing a polyester (Example 7), especially in terms of openness at chopping, or containing only a polyurethane (Example 8) which results in a large number of white strands.

The strands according to the invention thus prove to be easier to process than the strands currently proposed for the intended application, especially the strands coated with a size based on a polyester/epoxy mixture (Example C1) or on only a polyester (Example C3).

The strands according to the invention thus give the panel a better appearance, especially as regards the number of white strands, compared with the strands which are recommended more particularly for the manufacture of the intended panels, such as the strands of Example C2 coated with a poly(vinyl acetate)-based size. Compared with these same strands, the strands according to the invention furthermore allow a better tensile strength to be obtained.

The glass strands coated with the sizing composition which combines a polyurethane with a polyester in a weight ratio of less than or equal to 1.5, and preferably less than or equal to 1.0, are remarkable in that they possess both excellent openness at chopping (less than 30) and high reinforcement properties (especially a tensile strength of at least 100 MPa) while maintaining a translucency and a number of visible strands which are very satisfactory for the intended application.

(1) Sold under the reference “NEOXIL® 8200A” by DSM;

(2) sold under the reference “FILCO® 350” by COIM;

(3) sold under the reference “EMERY® 6760” by Henkel Corporation;

(4) sold under the reference “SILQUEST® A-174” by Witco Corporation;

(5) sold under the reference “SILQUEST® A-1128” by Witco Corporation;

(6) sold under the reference “ARQUAD® C35” by Akzo Nobel Chemichals.

1. A glass strand coated with a sizing composition comprising at least one polyurethane A and at least one polyester B in an A/B weight ratio of less than or equal to 3.

2. The glass strand according to claim 1, wherein the A/B weight ratio is between 0.05 and 2.

3. The glass strand according to claim 1, wherein polyurethane A has a molecular mass of less than 20 000.

4. The glass strand according to claim 1, wherein the polyurethane is obtained by the reaction of at least one polyisocyanate with at least one polyol having at least one of an aliphatic or cycloaliphatic chain.

5. The glass strand according to claim 1, wherein polyester B is obtained from the reaction of a poly(alkylene glycol) with at least one of a carboxylic acid or a carboxylic anhydride.

6. The glass strand according claim 5, wherein the polyester is obtained by the reaction of a poly(alkylene glycol) with phthalic anhydride and maleic anhydride.

7. The glass strand according to claim 1, further comprising at least on coupling agent and at least one lubricating agent.

8. The glass strand according to claim 7, wherein the coupling agent is a compound containing one or more acryloxy, methacryloxy, glycydoxy or amino functional organic groups.

9. The glass strand according to claim 8, wherein the coupling agent is a silane.

10. The glass strand according to claim 1, having a loss on ignition of less than 1.5%.

11. The glass strand according to claim 1 in the form of filaments having a diameter of from 9 to 16 μm.

12. The glass strand according to claim 1, having a linear density of between 15 and 60 tex.

13. A sizing composition capable of coating the glass strands according to claim 1, comprising:
at least one polyurethane A,
at least one polyester B,
at least one lubricating agents,
at least one coupling agent, and
water,
wherein the A/B weight ratio is less than 3.

14. The composition according to claim 13, comprising:
0.5 to 5% by weight of polyurethane A,
1.5 to 5.85% by weight of polyester B,
0.02 to 0.04% by weight of lubricating agent,
0.10 to 0.33% by weight of coupling agent, and
at least 90% water.

15. The composition according to claim 14, comprising:
2 to 5% by weight of polyurethane A, and
3.65 to 5.85% by weight of polyester B.

16. The composition according to claim 14, comprising:
0.65 to 1.65% by weight of polyurethane A, and
1.60 to 2.60% by weight of polyester B.

17. The composition according to claim 1, having a solids content of between 2 and 10% by weight.

18. The composition according to claim 1, further comprising at least one of an antistatic agent, crosslinking agent or an oxidizing agent.

19. A composite panel comprising at least one thermosetting polymer material and glass reinforcing strands, wherein all or some of the strands consist of strands according to claim 1.

20. The composite panel according to claim 19, wherein the polymer material is at least one of a polyester, vinyl ester, acrylic, phenolic resin or epoxy resin.

21. The composite panel according to claim 19, having a tensile strength of greater than 100 MPa.

22. The glass strand according to claim 1 wherein the A/B weight ratio is between 0.25 and 1.5.

23. The glass strand according to claim 1, wherein polyurethane A has a molecular mass of between 4,000 and 14,000.

24. The glass strand according to claim 9, wherein the coupling agent is an alkoxy silane.
